(19) United States
(12) Patent Application Publication
(10) Pub. No.: US 2012/0155593 A1
(43) Pub. Date: Jun. 21, 2012

(54) Detecting forgery of Art, Bonds and Other Valuables by Neutron Activation and Method Thereof

(76) Inventor: Ioan G. Crihan, New York, NY (US)

(21) Appl. No.: 12/974,255

(22) Filed: Dec. 21, 2010

(51) Int. Cl. G21G 1/12

(52) U.S. Cl. 376/157

(57) ABSTRACT

Apparatus and method for detecting forgery by neutron activation of art objects or other valuables such as bonds, wills, etc. comprising of a device applying neutron irradiation to a reference spot sufficient to produce radiation including gamma rays; immediately thereafter, a device and method of the invention determines and records the rate of emission as a function of time that results from the application of the thermal neutron irradiation to the reference spot and produces ‘initial’ data thereof; at one or several selected subsequent intervals thereafter, the device and method determines and records the quantitative measures of the radiation emission in the gamma ranges of energy emanating from the reference spot taken at time intervals after activation and produces ‘subsequent’ data, and a device and method compares ‘initial’ data with ‘subsequent’ data.

### BACKGROUND OF THE INVENTION

1. Field of the Invention

The present invention relates to an apparatus for detecting forgery of art objects or of other valuables, such as bonds, wills, etc. by neutron activation of pigments and other elements thereof. It includes according to at least one preferred embodiment of the invention, a device applying neutron irradiation in a “thermal range” of energy to a reference spot sufficient to produce a generally mild, temporary radiation emission in the gamma ray ranges. Immediately after irradiation by thermal neutrons, a device measures and records, for example by a computer, the rate of emission as function of time that results from the applying of the irradiation to the reference spot on the art objects or on other alleged valuables, such as bonds, wills, etc. This gives initial emission data. At one or several selected subsequent time intervals after the neutron activation, the same device measures a rate of emission in the desired region of the gamma spectrum from the activated spot in the art object or valuable professing to be the original. These quantitative measures of the radiation emission in the gamma ranges of energy emanating from the reference spot of the art objects or of other valuables taken at time intervals after activation are called ‘subsequent’ data. A device compares the ‘initial’ data with the ‘subsequent’ data. These various devices and methods are interpreted by one skilled in the art to indicate the origin of the material in the spot and by implication the origin of the object of art or other valuable, whether it is authentic or a forgery.

2. Background

Oil painting can be conceived as having a three dimensional structure. In depth, a typical painting comprises first a support, such as a wooden panel or a canvas, next a ground layer on which many applications of paint, frequently overlapping each other, are disposed or have been overlaid, and then a varnish layer covers these applied paint applications and its pigments. Autoradiographs of the three dimensional structure provide, for example, photographic images of the paints applications independent of whether they are visible on the surface or hidden below it. In combination with X-ray radiographic or photographic methods, the technique allows a detailed study of the structure of which a painting is composed. From this information, it is often possible to reconstruct an artist's painting technique. In addition, methods of infrared photography, either ordinary or false color, yields information about an artist methodology, but are not useful in confirming the origin of a painting, and likewise, with ultraviolet imaging methods. Such a combination of photographic X-ray radiography is not useful in identification of forgery.

It is found that in a given area of the painting, an application of neutron activation of the paint results in time-distinctive characteristics. These are found to provide information about the paint and its original applications. When the painting is thus irradiated by exposure to a flux of thermal neutrons, a mild temporary radioactivity is generated within the area of the irradiated zone on the painting. Most of the radioactivity is concentrated in the chemical components of the paint pigments within the painting.

It may be useful to summarize glossarial terms of art relating to the environment of the invention, as follows:

X-ray radiograph is a shadowgraph obtained by directing a beam of high energy light or X-ray through a painting onto a photographic film. The absorption of X-ray within the painting usually is predominately determined by the distribution of the very dense pigments, e.g. lead white, within the painting. The rays absorbed register less on the film so that these areas are light. The light and dark values on the film are similar to those of the painting, thus registering materials under the brush strokes and any generally imperceptible damage invisible on the surface of the art object.

False color infrared photography is infrared photography using a spectral color film which registers infrared light of different energies or wavelengths with images of different colors. Since none of the infrared light is actually visible, the color response is termed a ‘false’ one. Pigments of similar hue of visible light might show up with quite different colors in this photography, hence the method may frequently discriminate between such pigments.

Ultraviolet photography is photography by light whose energy is greater than that of visible light. Because the varnish film fluoresces, and there is less of this film over repaired areas or portions thereof, these repaired areas of a painting will appear darker.

Radioactivity is the emission of various types of high energy particles from unstable atomic nuclei present within matter.

Decay-rate (half life) is the rate at which the particle emission of a radioactive species diminishes as the amount of this species decreases through its decay. The laws of radioactivity decay are such that in a given period of time, its half life, i.e., one-half of the amount of a radioactive species present at the start of this period, would have decayed away.

Gamma rays are high energy particles of light and/or photons, emitted from a radioactive species during its decay.

Neutron activation of a painting or other valuable is exposure to or irradiation by a cloud of low energy of thermal neutrons. During irradiation, a mild, temporary radioactivity is generated within the painting. Most of the radioactivity is concentrated in the components of the paint pigments. The painting is thus irradiated with thermal neutrons.

Pigment is a substance, generally a powdered substance, that imparts black, or white, or a color, to other materials, particularly a powdered substance that is diluted or mixed with a liquid medium which is relatively insoluble and used especially to impart color, or colors, to coating materials, or to inks, plastics, and rubber; as a mixture it is often referred to as a paint.

The known prior uses show various types of detection arrangements and various manufactures and the like as well as methods of their construction, but none of them whether taken singly or in combination discloses the specific details of the combination or system of the invention in such a way as to bear upon the claims of the present invention.

Unlike the methods of the prior art, in which the tests take long periods of time, days or months for example, the present invention performs the test in very short period of time, namely seconds or minutes.

### SUMMARY OF THE INVENTION

An object of the invention is to provide a novel and improved apparatus and method for detecting evidences of identity, or of possible forgery, in objects of art and other valuables such as bonds, wills, etc. by a process of mildly irradiating the painting by exposure to a flux or beam of thermal neutrons. During irradiation, a mild temporary radioactivity is generated within the painting or other valuable. Most of the radioactivity is concentrated in the components of the pigments in the painting.

Another object of the invention is directed further to a method of recording, by a gamma detector, and comparing the different energies of the pigments in brief, specified, consecutive times after application of irradiation to a painting. Such testing of pigments, by neutron activation, identifies pigment composition. One skilled in the art can easily compare such pigment composition with those used in the period in which the artist lived. If a pigment is from another time, it may be classified as a forgery.

Another object of the invention is a process for registering into the computer the gamma rays emitted from the materials for detection and measurements. These measurements allow one skilled in the art to readily determine which elements are present in the pigment in order to make comparisons with other analyses of pigments. These measurements may also be used to construct a graph by appropriate instrumentation, in which the graph depicts ‘relative emission rates’ depicted as a function of ‘time’. For example, the pigments vermillion (mercury sulfide, mercuric sulfide), zinc white (zinc oxide), orpiment (arsenic sulfide, arsenic trisulfide) and ocre (iron oxide) will be emitting gamma rays of mercury, zinc, arsenic and iron, respectively, in intensities that reflect their respective composition.

These together with other objects and advantages which will become subsequently apparent reside in the details of the process and operation thereof as more fully hereinafter is described and claimed, reference being made to the accompanying drawings forming a part hereof, wherein like numerals refer to like parts throughout.

### DESCRIPTION OF THE SEVERAL VIEWS OF THE DRAWINGS

FIG. 1 is a graphic plot of metallic radiation according to ‘Time After Activation’ vs ‘Relative Emission Rates’ and illustrating typical data used in an installation of an arrangement for detecting forgery in art object by neutron activation according to a preferred embodiment and best mode of the present invention.

FIG. 2 is a diagrammatic and schematic representation of the apparatus of the invention as applied to a painting for verifying identity of and detecting forgery of an art object or other valuables, such as bonds, wills, etc. by neutron activation.

### DESCRIPTION OF A PREFERRED EMBODIMENT OF THE INVENTION

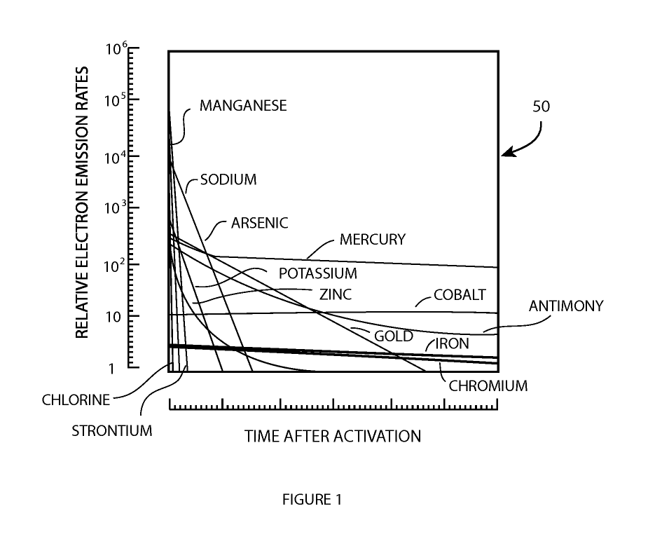

Referring now to the drawings there is in FIG. 1 a graphic plot of metallic radiation showing ‘Time After Activation’ vs ‘Relative Emission Rates’.

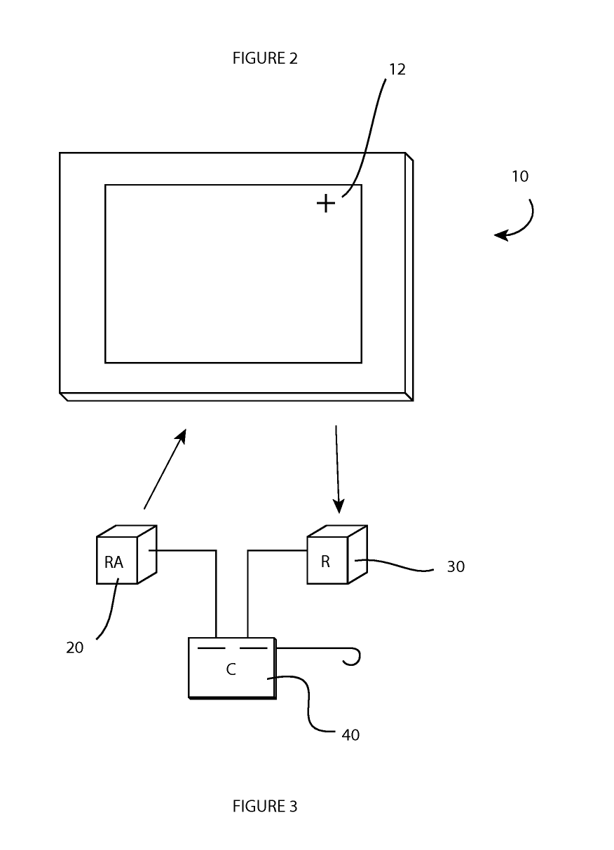

FIG. 2 shows an art object or oil painting 10 having a reference spot 12 on which tests for verifying its identity or detecting its forgery are to be applied by neutron activation member 20. In order to select the proper spot for neutron activation, the oil painting is first X-rayed in order to identify the area of about two inches square which shows a minimum of over-painting and which gives some assurance that the pigment or paint is not a restored spot. It has been found that a preferred place for locating the area is the area usually associated with the artist's signature, or the signatures of valuables such as bonds, wills etc. While it is known that over time paintings are tampered with in various places but seldom in the area containing the artist's signature because this has been found as the most difficult to forge or modify.

Neutron activation is accomplished at an energy in the present method using a beam of energy of 24.3 keV; a width (FWHM) of 1.0 keV, a size (cm) of 7.27×2.8 in intensity (n/sec); 1.5×108; and the period of time is divided in regular fixed intervals ranging from seconds upwardly, preferably up to 60 minutes.

The reference spot 12 is on the oil painting 10 and is conceived of as having essentially a three dimensional structure; in depth, it comprises a support, such as a wooden panel or of a canvas, next a ground layer on which many applications of paint, frequently overlapping each other, are disposed or have been laid, and then a varnish layer covers these paint applications, and therefore comprise the reference spot 12. Elements generally found present in pigments used in oil paintings 10 are such as iron, zinc, barium, mercury, chromium, arsenic, antimony, manganese, copper, potassium, sodium, chlorine, strontium, gold, aluminum, and some few others.

Neutron activation member 20 is used to apply neutron irradiation to reference spot 12 of the oil painting 10 that are generally low intensity, mild, and results in temporary gamma emission sufficient to produce gamma rays on the reference spot 12.

Immediately thereafter, a recording member 30 determines and records the emission rate as a function of time in the desired region of the gamma spectrum that results from the neutron irradiation at the reference spot 12 on the oil painting 10 and it produces indicative therein ‘initial’ data of the reference spot.

At one or several selected subsequent intervals thereafter, the recording apparatus 30 determines and records the emission rate in a specified range of gamma energy as a function of time in quantitative measures of radiation emission in the gamma ranges of energy emanating from the reference spot 12 of the oil painting 10 taken at time intervals after activation and produces indicative ‘subsequent’ data.

Comparative apparatus 40 accepts the ‘initial’ data of the neutron activation apparatus 20 and the ‘subsequent’ data of the recording member 30 to provide a graph or indication of any conventional form for issuing from the comparison apparatus 40 a certification document indicating a condition of authenticity or non-authenticity, and state of the oil painting 10.

The reference spot 12 may contain metallic components, including aluminum, that produce gamma rays.

In order to select the proper applicable spot, the oil painting is first X-rayed in order to perceive an area of about two inches square which shows a minimum of over-painting thereof and there is some assurance that the pigment or paint is not a restored spot. It has been found that a preferred place for locating the area is the area usually associated with the artist's signature. While it is known that paintings are tampered with, but seldom is the area containing the artist's signature defiled because this has been found as the most difficult to forge.

The energy used by the present method is a beam energy of 24.3 keV; a width (FWHM) of 1.0 keV; a size of 7.27×2.8 in intensity (n/sec); 1.5×108; and the period of time is divided in regular fixed intervals ranging from seconds upwardly, preferably up to 60 minutes.

The comparison member 40 may have stored therein data that provides construction of a graph of the report 50 (FIG. 1) depicting ‘Time After Activation’ vs ‘Relative Emission Rates’ of FIG. 1. The comparison apparatus 40 may control the neutron activation apparatus 20 to generate a generally mild, temporary radioactivity adequate for a determined time interval.

After the neutron activation member 20 is reapplied it thereupon activates the elements of the reference spot 12.

Example 1 shows a table according to the invention using the following parameters:

| | Time Interval | | |
|---|---|---|---|
| Number | After Irradiation | | Relative Emission Rates |
| 1 | 1-5 | seconds | |
| 2 | 5-10 | seconds | |
| 3 | 10-15 | seconds | |
| 4 | 15-20 | seconds | |
| 5 | 20-25 | seconds | |
| 6 | 25-30 | seconds | |
| 7 | 30-40 | seconds | |
| 8 | 40-50 | seconds | |
| 9 | 50-60 | seconds | |
| 10 | 1-5 | minutes | |
| 11 | 5-10 | minutes | |
| 12 | 10-15 | minutes | |
| 13 | 15-20 | minutes | |
| 14 | 20-25 | minutes | |
| 15 | 25-30 | minutes | |
| 16 | 30-60 | minutes | |

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

I claim:

1. A method of identifying the material composition of an art object having elements within pigments thereof which are responsive to neutron activation, comprising
applying neutron irradiation to the art object sufficient to produce gamma rays;
at a predetermined time interval after the application of the neutron radiation, recording the level of emission of radiation from the art object as a function of time resulting from the application of the neutron irradiation to the art object.

2. The method of identifying the composition of an art object of claim 1, further comprising:
x-raying the art object to identify an area of the art object to determine the level of overpainting on the art object.

3. The method of identifying the composition of an art object of claim 1, further comprising:
x-raying the art object to identify an area of the art object to determine the level of overpainting on the art object;
selecting an area of the art object to be irradiated based on the measured level of overpainting in that area of the art object;
focusing the neutron irradiation of the art object directed on the selected area.

4. The method of identifying the composition of an art object of claim 1, further comprising:
after at least a second predetermined time intervals after the first time interval, recording a quantitative measure of the radiation emission in the gamma ranges of energy emanating from the selected area of the art object taken at the time intervals after activation.

5. The method of identifying the composition of an art object of claim 1, further comprising:
after a plurality of second predetermined time intervals after the first time interval, recording a quantitative measure of the radiation emission in the gamma ranges of energy emanating from the selected area of the art object taken for each of the second time intervals after activation;
producing a chart of recorded radiation emission levels versus time after neutron irradiation.

6. The method of identifying the composition of an art object of claim 1, wherein the selected area contains metallic components that produce gamma rays in response to the neutron radiation.

7. The method of identifying the composition of an art object of claim 1, wherein the selected area contains the signature by the art object artist.

8. The method of claim 1 wherein the radiation application generates a generally mild, temporary radioactivity adequate for a determined time interval, and the neturon is reapplied to again activate elements of the selected area.

9. The method of claim 1 wherein the means producing gamma rays provides no damage or visible alterations or destruction in art objects or other valuables

10. The method of claim 1 wherein the ‘subsequent’ data is determined by the following quantification of radiation and gamma rays:

11. The method of identifying the composition of an art object of claim 1, further comprising:
after a plurality of second predetermined time intervals after the first time interval, recording a quantitative measure of the radiation emission in the gamma ranges of energy emanating from the selected area of the art object taken for each of the second time intervals after activation;
producing a chart of radiation emission rates versus time after neutron irradiation calculated from the recorded radiation emissions.

12. The method of identifying the composition of an art object of claim 1, further comprising:
calculating the material composition of the art object from the recorded level of radiation emission from the art object.

13. The method of claim 13, wherein the calculation calculates element levels in the art object including iron, zinc, barium, mercury, chromium, arsenic, antimony, manganese, copper, potassium, sodium, chlorine, strontium, aluminum, and gold

14. The method of identifying the composition of an art object of claim 1, wherein the measured level of radiation is a radiation emission rate from the painting.

15. The method of identifying the composition of an art object of claim 1, wherein the measured level of radiation is the amount of radiation emitted rate from the painting.

16. Method of obtaining ‘signature’ characteristics from pigments disposed on a surface of an oil painting [or other valuables such as bonds, wills, etc)] comprising the steps of:
selecting a relatively tiny reference area on the surface of the oil painting containing the pigments,
X-raying the pigments for determining that the tiny reference area is not restored,
applying a selected quantity of neutron irradiation to the pigments of the reference area comprising of a beam energy of 24.3 keV having a width of 1.0 keV, having a size of 7.27×2.8 cm, and having an intensity of per n/sec of 1.5×10⁸, all for a selected period of time sufficient to produce data of measurable gamma radiation therefrom
recording the period of time for the applying the neutron irradiation,
detecting thereafter at a one or more subsequent time intervals the data as a one or more subsequent initial ‘signature’ characteristics of the gamma radiation,
at the one or more subsequent time intervals, detecting a change in the one or more subsequent initial ‘signature’ characteristics of the gamma radiation,
comparing the one or more subsequent initial ‘signature’ characteristics of the gamma radiation with the one or more subsequent initial ‘signature’ characteristics of the relatively tiny reference area on the surface of the pigments of the oil painting, and
recording the comparison for subsequent use.

17. The method of identifying the composition of an art object of claim 16, wherein the selected area contains metallic components that produce gamma rays in response to the neutron radiation;
using a computer to identify the amount metallic components in the selected area that produce gamma ray emissions from the art object.
d of identifying the composition of an art object of claim 1, wherein the selected area contains the signature by the art object artist.

18. A method of verifying identity of and detecting forgery of an art object at a reference spot on the art object having elements within pigments thereof which are responsive to neutron activation comprising the steps of
a. selecting a reference spot on the art object,
b. applying neutron irradiation to the reference spot of the art object sufficient to produce gamma rays,
c. at a selected immediate interval thereafter, recording the time of the application of the neutron irradiation to the art object and recording the level of emission as a function of time that result from the applying of the neutron irradiation to the reference spot of the art object and producing ‘initial’ data thereof,
d. repeating step c) at selected subsequent time intervals thereafter, recording the time since irradiation and the level of energy emanating from the reference spot of the art object taken at the subsequent time intervals after activation;
comparing the level of irradiation from the art object at the subsequent time intervals with the level of irradiation at the selected immediate time interval data with the ‘subsequent’ data.

19. The method of claim 18 wherein the spot contains metallic components that produce the gamma rays

20. The method of claim 18 wherein the art object is a negotiable instrument and the reference area is a signatory area of the art.
